(19) United States
(12) Patent Application Publication
(10) Pub. No.: US 2004/0228772 A1
(43) Pub. Date: Nov. 18, 2004

(54) Method and apparatus for processing biological and chemical samples

(75) Inventors: Xiaoxi Chen, Waltham, MA (US); Michael Shanler, Bedford, MA (US)

Correspondence Address: HOFFMAN & BARON, LLP, 6900 JERICHO TURNPIKE, SYOSSET, NY, 11791, US

(73) Assignee: Becton, Dickinson and Company

(21) Appl. No.: 10/844,774

(22) Filed: May 13, 2004

Related U.S. Application Data
(60) Provisional application No. 60/469,986, filed on May 13, 2003.
(60) Provisional application No. 60/470,021, filed on May 13, 2003.
(60) Provisional application No. 60/538,913, filed on Jan. 23, 2004.
(60) Provisional application No. 60/548,922, filed on Mar. 1, 2004.

(51) Int. Cl. B01L 3/00

(52) U.S. Cl. 422/102

(57) ABSTRACT

The subject invention provides a target support plate and an assembly of a target support plate and a target device for processing biological and chemical samples The target support plate includes spaced-apart top and bottom surfaces, and a plurality of columns extending between, and through, the top and bottom surfaces. The target support plate may be releaseably secured to the target device by an elastomeric seal with the target support plate being at least partially formed of an elastomeric material; an adhesive; an elastomeric gasket; and/or, a mechanical fixation. The target device may be a device for collecting samples, including a multi-well plate, a mass spectrometric plate, or a secondary target support plate.

### CROSS-REFERENCE TO RELATED APPLICATIONS

This application claims priority of U.S. Provisional Patent Application No. 60/469,986, filed May 13, 2003; U.S. Provisional Patent Application No. 60/470,021, filed May 13, 2003; U.S. Provisional Patent Application No. 60/538,913, filed Jan. 23, 2004; and U.S. Provisional Patent Application No. 60/548,922, filed Mar. 1, 2004, all of which are hereby incorporated by reference.

### FIELD OF INVENTION

This invention relates to methods and apparatuses for processing biological and chemical samples.

### BACKGROUND OF THE INVENTION

Deposition of biological/chemical samples as small spots on a surface of a solid substrate for subsequent analysis or applications is a useful technique in many fields including mass spectrometry and microarray technology. In microarray applications, small quantities of biological/chemical sample solutions, such as antibody solutions, are deposited on a solid substrate to form a high density array of spots. The contents of the sample solutions, such as antibodies, are immobilized on the substrate surface within an area determined by the size of the spots. The ability of depositing a large number of different samples on a surface in a high density array format is a foundation for microarray applications. In fact, deposition of biological/chemical samples as spots on a sample plate is a key sample preparation step in mass spectrometry applications, including MALDI (Matrix-Assisted Laser Desorption Ionization), SELDI (Surface Enhanced Laser Desorption/Ionization) and DIOS (Desorption/Ionization On porous Silicon) mass spectrometry.

Conventional techniques exist for conducting mass spectrometric analysis of large molecules, e.g., using MALDI plates. Typically with these techniques, liquid solutions (including e.g., peptide, protein and energy absorbing matrix) are initially introduced to pre-defined target sites on a mass spectrometric plate. Since the diameter of the target sites are generally small and often densely packed, small (e.g., 0.5-2 microliter) droplets of the liquid solutions are disposed onto the plate target sites to achieve proper sample placement and to avoid sample overlap between target sites. Once disposed, the liquid samples are evaporated, with matrix crystal conglomerate containing analyte molecules (e.g., peptides and proteins) remaining on the target sites having favorable characteristics for mass spectrometric analysis. Where larger conglomerate samples are desired, serial liquid sample placement and evaporation has been used to iteratively build-up a conglomerate.

Since mass spectrometric plates are generally flat, various techniques have been developed for attracting and/or maintaining the liquid samples at the plate target sites. For example, MALDI plates have been formed with a hydrophobic masking (e.g., polytetrafluoroethylene) over a hydrophilic substrate with the target sites being exposed. In addition, MALDI plates have been formed with etched features which define wells encompassing the target sites with the liquid samples being maintained therein due to surface tension. The approaches are still limited by the small volume (5-10 microliters) of the liquid solutions that can be disposed onto the plate target sites to achieve proper sample placement and to avoid sample overlap between target sites.

Separately, multi-well filter plates with a small chromatography column incorporated at the bottom of each well have been known to be used for sample preparation in mass spectrometry. One typical example of a multi-well filter plate is commercialized under the brand name ZipPlate®. Using the ZipPlate device, the processed samples are pulled through the chromatography columns and directly deposited on a MALDI plate using a vacuum system. Because the processed samples coming from the wells necessarily travel in the air for a small distance before it reaches the MALDI plate surface, a delicate design is required to ensure that the sample solutions coming out of the neighboring wells do not contaminate each other when being deposited on the plate surface. Also, because air leakage in one well may result in reduced air pressure in other wells, a delicate design is required to ensure that the air pressure applied on each sample is consistent from well to well.

The aforedescribed prior art multi-well plates suffer drawbacks including being formed of rigid plastic (e.g., polystyrene or polypropylene) and failing to have the ability to couple to the MALDI target plate to allow for centrifugation therewith.

### SUMMARY OF THE INVENTION

The subject invention, in one aspect, provides an assembly for processing biological and chemical samples, the assembly including a target support plate having spaced-apart top and bottom surfaces, and a plurality of columns extending between, and through, the top and bottom surfaces; and, a target device releasably secured to the target support plate, the target device having collection sites for collecting the samples with the columns at least partially registering with the collection sites. Advantageously, with the subject invention, a target device (e.g., a multi-well plate, a sample plate for mass spectrometry, a secondary target support plate) can be releasably secured to the target support plate to allow for chemical and biological samples to be prepared therewith. Samples can be efficiently transmitted to a target device having been filtered or processed otherwise without requiring pipetting, or other transference, thereby minimizing cross-contamination.

In a further aspect of this subject invention, a target support plate is provided having spaced-apart top and bottom surfaces, and a plurality of columns extending between, and through, the top and bottom surfaces, wherein, at least the bottom surface of the target support plate is formed of an elastomeric material releasably adhereable to a target device. By using a releasably adhereable elastomeric material, preferably a silicon polymer, and more preferably a poly(dimethyl)siloxane, a target support plate can be directly releasably secured to a target device.

In yet a further aspect of the subject invention, a target support plate assembly is provided which includes a target support plate having spaced-apart top and bottom surfaces, and a plurality of columns extending between, and through, the top and bottom surfaces. Further, a means for releasably securing the target support plate to a target device is also provided. Preferably, the means for releasably securing the target support plate includes an elastomeric gasket, an adhesive and/or a mechanical fixation.

Various methods can be practiced with the invention described herein, including preparing a sample target plate for mass spectrometry. Furthermore, samples can be filtered and otherwise processed in preparation for analysis.

These and other features of the invention will be better understood through a study of the following detailed description and accompanying drawings.

### BRIEF DESCRIPTION OF THE DRAWINGS

FIGS. 1(a)-1(d) show various column configurations of a target support plate;

FIGS. 2 and 3 show an assembly of a target support plate and a target device;

FIGS. 4 and 5 show a target support plate having a recessed section defined to accommodate a target device;

FIG. 6 shows a cross-section of a target support plate/target device assembly, wherein a mechanical fixation is used to releasably secure the target device to the target support plate;

FIG. 7 is an enlarged view of section 7 from FIG. 6;

FIG. 8 is a partial cross-section of a target support plate/target device assembly wherein, adhesive is used to releasably secure the target device to the target support plate;

FIG. 9 is a partial cross-section of a target support plate/target device assembly wherein an elastomeric gasket is used to releasably secure the target device to the target support plate;

FIG. 10 shows a schematic of a process used to prepare a target device for analysis, wherein the target device is a mass spectrometric plate (e.g., a MALDI plate);

FIG. 11 shows an assembly of a target support plate and a target device, wherein the target support plate includes a filter and filtration media and the target device is a multi-well plate;

FIG. 12 shows an assembly of a first target support plate, having a filter and filtration media disposed therein, a secondary target support plate, and a target device in the form of a mass spectrometric plate (e.g., a MALDI plate) releasably secured to the secondary target support plate;

FIG. 13 shows a schematic of a process for preparing a target device for analysis using the assembly of FIG. 12, wherein the target device is a mass spectrometric plate (e.g., a MALDI plate); and,

FIG. 14 shows a variation of the process of FIG. 13, wherein the sample for analysis may be purified.

### DETAILED DESCRIPTION OF THE INVENTION

Various configurations of a target support plate are shown and described herein. Advantageously, with the subject invention, a target device (e.g., a multi-well plate, a sample plate for mass spectrometry, a secondary target support plate) can be releasably secured to the target support plate to allow for chemical and biological samples to be prepared therewith. Samples can be efficiently transmitted to a target device having been filtered or processed, and may be transmitted without requiring pipetting, or other transference, thereby minimizing cross-contamination.

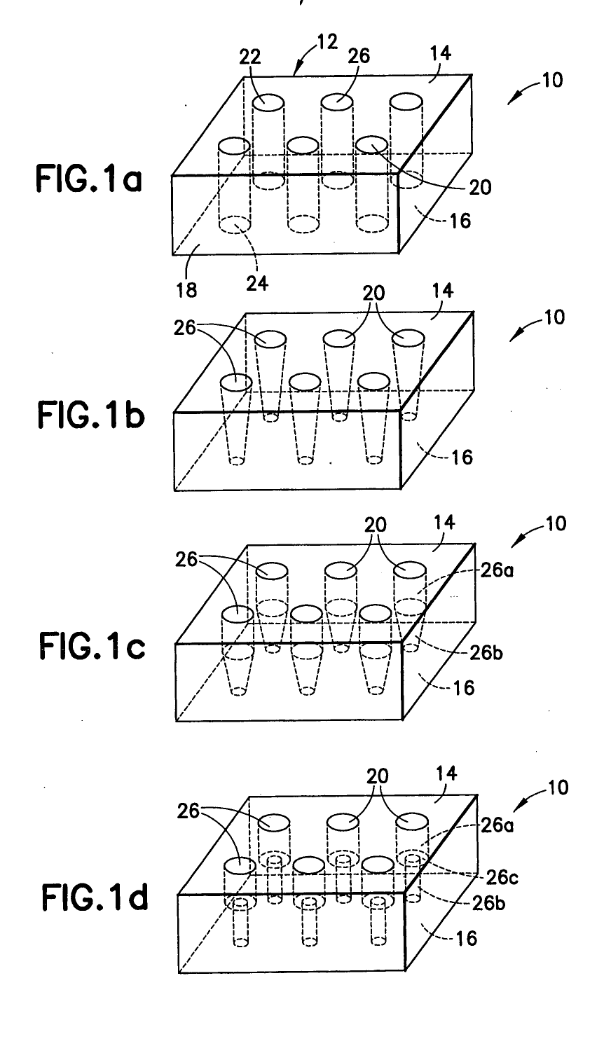

More specifically, and with reference to FIGS. 1(a)-(d), various configurations of a target support plate 10 are shown having a body 12 with top and bottom surfaces 14 and 16, and a plurality of sidewalls 18. One or more columns 20 extend between, and through, the top and bottom surfaces 14 and 16. Consequently, the columns 20 each include an open top end 22, that is coextensive with the top surface 14, and an open bottom end 24, that is coextensive with the bottom surface 16. As is readily appreciated, the columns 20 define open passages completely through the body 12. The body 12 may be formed of any conventional material used to form multi-well plates, such as polypropylene or polystyrene, unless described to the contrary. Preferably, at least a portion of the bottom surface 16 is formed flat. The bottom surface 16, having the open bottom ends 24 formed therethrough, must be configured to provide sufficient surface area for sealing and preventing cross-contamination, as described below (i.e., sufficient surface area is to be provided at intervals between the open bottom ends 24).

Any number of the columns 20 may be utilized. In addition, the columns 20 can be arranged in any pattern in the body 12, including being arranged in known arrays used commonly with multi-well plates (e.g., arrays of 96 columns (12×8), 384 columns (16×24), 1,536 columns (32×48), or other multiples of 12).

Each of the columns 20 includes a column sidewall 26 which may be formed with various geometric configurations. For example, as shown in FIG. 1(a), the column sidewalls 26 may be generally cylindrical. Alternatively, as shown in FIG. 1(b), the column sidewalls 26 may by frusto-conical. Preferably, where a frusto-conical configuration is used, the columns 20 are formed to converge towards the bottom surface 16. Furthermore, the column sidewalls 26 may be formed with non-constant geometric configurations or of combined geometric configurations, such as in FIG. 1(c), where the column sidewall 26 includes a first column sidewall portion 26a that is cylindrical and a second column sidewall portion 26b that is frusto-conical. The first and second column sidewall portions 26a and 26b may also be both cylindrical, but of different diameters, such that, as shown in FIG. 1(d), an annular intermediate surface 26c is defined at the intersection of the two sidewall portions 26a and 26b. The intermediate surface 26c may provide a support surface for a flit or filter, which in turn may support a filtration media, as further described below. As will be appreciated by those skilled in the art, the column sidewalls 26 may be formed with other configurations.

Depending on the use of the target support plate 10, the column sidewalls 26 may be treated to enhance the performance of sample preparation, such as, for example, enhancing the detection sensitivity in preparing samples for mass spectrometry. The column sidewalls 26 can be modified to provide reactivity or affinity for certain biological/chemical samples. In another example, the column sidewalls 26 can be modified to minimize non-specific binding of various biological/chemical substances such as proteins/peptides. This approach may aid in avoiding sample loss to the column sidewalls 26. In yet another example, the column sidewalls 26 can be modified to specifically bind a class of biological/chemical substances such as a particular class of proteins/peptides/nucleotides or a species of small-molecules. This approach is useful where the partial or entire removal of a class of biological/chemical substances from the original liquid sample mixture is desired. In mass spectrometry applications, e.g., MALDI, this approach will be useful where the partial removal of some components will decrease the background of the mass spectrometry and increase the sensitivity of detection for other components.

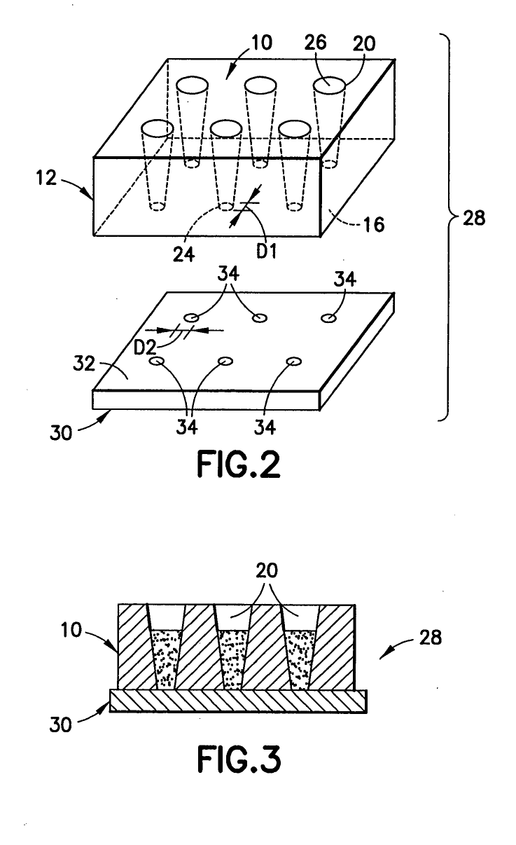

With reference to FIGS. 2 and 3, an assembly 28 may be provided of the target support plate 10 and a target device 30. The target support plate 10 is formed to be releasably secured to the target device 30. The target device 30 may be any device for collecting samples, including a multi-well plate, a mass spectrometric plate, or a secondary target support plate.

The target device 30 includes an upper surface 32 which faces the bottom surface 16 of the target support plate 10 with the assembly 28 being assembled. To provide sufficient surface area for sealing, it is preferred that at least a portion of the upper surface 32 be formed flat. In a first variation of the subject invention, at least the bottom surface 16 of the target support plate 10 is formed of an elastomeric material which can be releasably secured to the upper surface 32 of the target device 30. It is preferred that the elastomeric material include a silicon polymer, and more preferably, include poly(dimethydsiloxane (PDMS). The elastomeric material may also be doped with other polymers to customize its physical properties. With an elastomeric material, van der Waals interactions between the surface molecules of the target support plate 10 and the target device 30 provide for a releasable securement. The target support plate 10 can be pressed onto the target device 30 for securement and removed therefrom by peeling. It is further preferred that the body 12 of the target support plate 10 be wholly formed of the elastomeric material, more preferably being wholly formed of PDMS. The elastomeric and hydrophobic natures of PDMS allow for a tight bond to be formed between the target support plate 10 and the target device 30. With the target support plate 10 being only partially formed of the elastomeric material, remaining portions may be formed of rigid plastic or other material which will impart favorable characteristics to the column sidewalls 26.

The target device 30 includes one or more collection sites 34 for collecting biological and chemical samples that are to be processed as described below. The collection sites 34 may be individual wells of a multi-well plate, target sites on a mass spectrometric plate, or columns of a secondary target support plate. It is preferred that the columns 20 be provided in such quantity and be arranged to preferably register with the collection sites 34 in a one-to-one correspondence, although such correspondence is not required. It is also preferred that the bottom ends 24 of the columns 20 each define a diameter D1 that is equal to, or greater than, the size D2 of the collection sites 34. In this manner, liquid samples disposed within the columns 20 will cover the respective entireties of the collection sites 34. Where desired, the diameter D1 can be made less than the size D2.

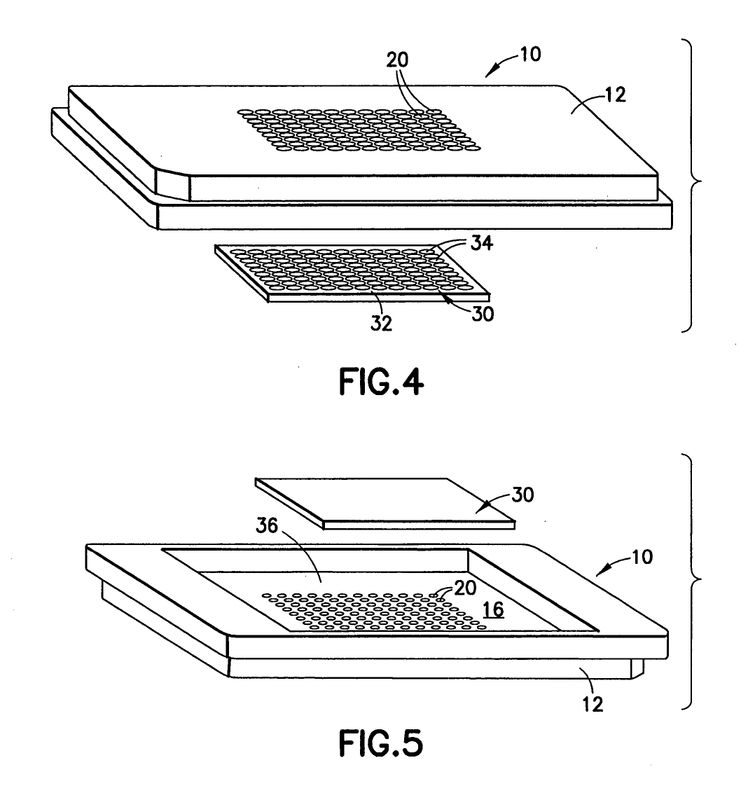

The target support plate 10 can be formed of various sizes and configurations. To allow for the target support plate 10 to be used with common pick-and-place machines and other standard multi-well plate equipment, the target support plate 10 can be formed with the same footprint as a common multi-well plate (e.g., such as the footprint specified in the standards of the Society for Biomolecular Screening (Standards SBS-1 through SBS-5)). In addition, as shown in FIGS. 4 and 5, the target support plate 10 may be formed larger than the target device 30. The bottom surface 16 may be recessed, as best shown in FIG. 5, with a recessed section 36, being defined in which the target device 30 may be wholly accommodated without protruding from the footprint of the body 12.

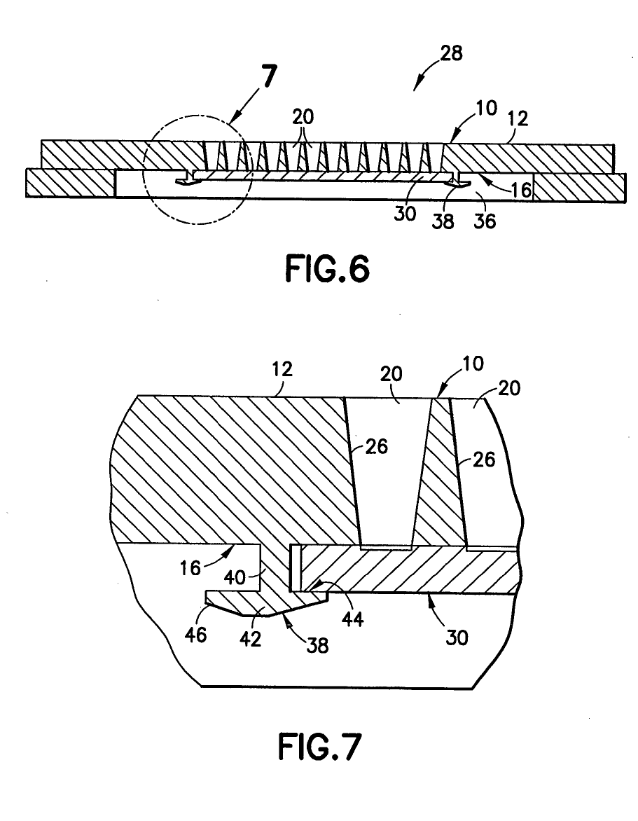

In addition to relying on elastomeric sealing to provide a releasable securement between the target support plate 10 and the target device 30, other releasable securement configurations may be utilized. With reference to FIGS. 6 and 7, a mechanical fixation is disclosed, wherein a mechanical locking member 38 may be provided which protrudes from the bottom surface 16 to at least partially bound the target device 30. The locking member 38 includes an upstanding support member 40 and a transverse member 42. The upstanding support member 40 and the transverse member 42 are formed such that a portion of the target device 30 is interposed between an engagement surface 44, defined on the transverse member 42, and the bottom surface 16. The transverse member 42 may also include a rearwardly, extending protruding member 46. The target device 30 can be “snapped” into releasable securement with the locking member 38 deflecting and returning to the position shown in FIGS. 6 and 7. Removal of the target device can be achieved by rearward displacement of the protruding member 46 resulting in moment being applied about the upstanding support member 40, deflection of the locking member 38, and separation of the engagement surface 44 from the target device 30. As can be appreciated, the strength of the holding force applied to the target device 30, as well as the difficulty of securement and removal of the target device 30, will be a function of the strength of the locking member 38, and the extent to which the locking member 38 bounds the target device 30.

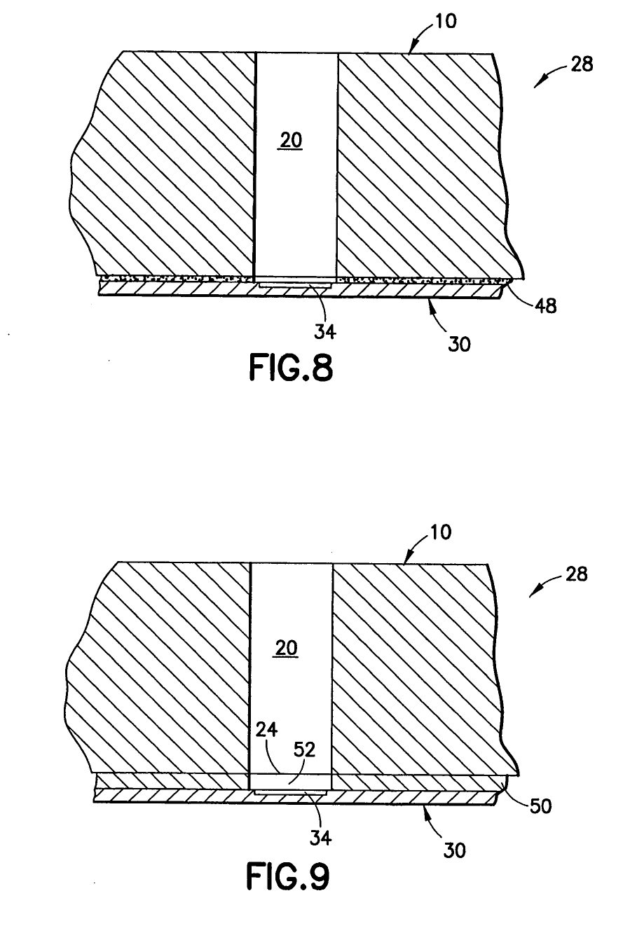

As shown in FIG. 8, adhesive 48 may be used to releasably secure the target device 30 to the target support plate 10. Any suitable adhesive may be used which will allow for release of the target support plate 10, yet provide sufficient holding force to the target support plate 10 to allow for preparation of the collection sites 34.

As shown in FIG. 9, an elastomeric gasket 50 may be interposed between the target device 30 and the target support plate 10 to provide releasable securement therebetween. In the same manner as described above with the body 12 of the target support plate 10 being formed of an elastomeric material, the elastomeric gasket 50 provides releasable adhesion. This adhesion may be achieved by van der Waals interactions. Preferably, the elastomeric material of the gasket 50 includes silicon polymer, and more preferably, includes poly(dimethyl)siloxane (PDMS). The elastomeric material may also be doped with other polymers to customize its physical properties. It is further preferred that the elastomeric gasket 50 be wholly formed of PDMS. Apertures 52 shall be formed in the gasket 50 as required to expose the intended collections sites 34. It is preferred that the apertures 52 each have a diameter that is greater than, or equal to, that of the respective open bottom ends 24.

As will be understood by those skilled in the art, regardless of the manner by which releasable securement is achieved, it is desired that sufficient sealing be provided along the interface between the target support plate 10 and the target device 30 to prevent cross-contamination of any liquid samples contained in the columns 20. The sealing should be at least fluid-tight. In addition, the level of strength of the releasable securement must be considered in view of any processing steps the assembly 28 is to be subjected to. Adhesive and elastomeric sealing will generally provide a weaker holding force than a mechanical fixation and may be used with smaller volume liquid samples and/or lighter target devices; whereas, a mechanical fixation may be used with larger liquid samples and/or heavier target devices. This is particularly so where the assembly 28 is intended to be centrifuged or otherwise transported together with releasable securement being maintained. On the other hand, the target device 30 should be detached without damage thereto. The various forms of releasable securement can be used in varying combinations (for example, adhesive may be used in combination with mechanical fixation).

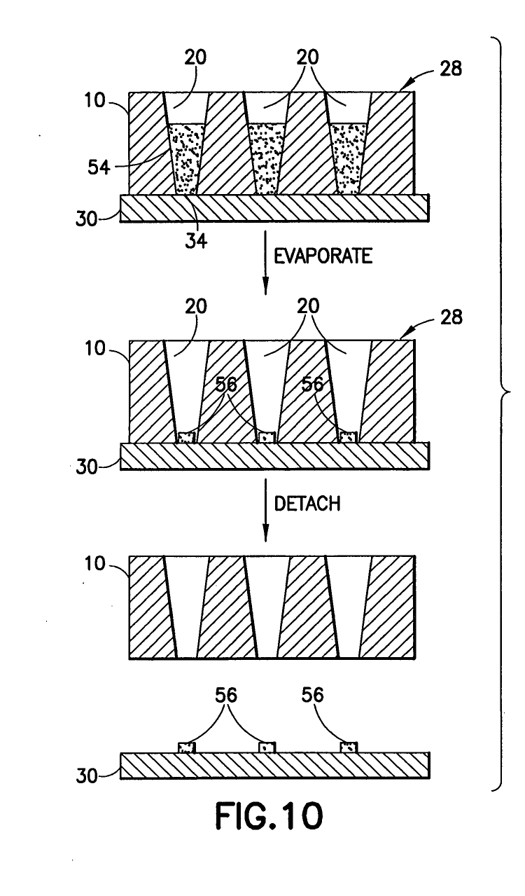

With reference to FIG. 10, an exemplary process is shown therein for preparing a chemical or biological sample for analysis. In particular, the assembly 28 is prepared, wherein the target support plate 10 is releasably secured to the target device 30 using any of the aforementioned techniques. As shown in FIG. 10, the target device 30 may be a mass spectrometric plate, such as a MALDI plate, a SELDI plate, or a DIOS plate. Once the assembly 28 is prepared, liquid samples 54 (which may contain an energy absorbing matrix such as α-cyano-4-hydroxy cinnamic acid, 3,5-dimethoxy-4-hydroxy cinnamic acid, or 2,5-dihydroxybenzoic acid) are disposed in the columns 20. The columns 20 define fluid-collecting wells collectively with the target device 30, particularly with the collection sites 34 which are in registration with the columns 20. The liquid samples 54 are caused to evaporate, such as through bench evaporation or evaporative centrifugation. After the liquid is evaporated from the liquid samples 54, conglomerates 56 are left on the collection sites 34 suitable for further analysis. The target device 30 is released from the target support plate 10 to allow for any such further analysis.

For the preparation of mass spectrometry, the column sidewalls 26 may be pre-coated with matrix molecules and/or mass spectrometry standards that are re-suspended upon addition of the liquid samples 54. The matrix and/or standards will be found in the conglomerates 56 after evaporation.

Advantageously, the subject invention allows for much larger liquid sample volumes to be used in preparing samples for mass spectrometry analysis, than with prior art techniques. Volumes of the liquid samples 54 may be in the range of 100 to 200 microliters, as opposed to the 1-5 microliters used in the prior art. As such, much greater material concentration in the conglomerate 56 can be achieved than with the prior art. In particular, with reference to the mass balance principle, the product of a first concentration (C1) and a first volume (V1) of a liquid sample equals the product of a second concentration (C2) and a second volume (V2) of the same liquid sample. The liquid samples 54 each have an initial first concentration C1, and an initial first volume V1. Because of evaporation, the resulting volume V2 of the liquid samples 54 is greatly reduced as compared to the initial volume V1. As such, the resulting concentration C2 of the resulting volume V2 is greater than the initial concentration C1, due to the volume reduction Although the subject invention is particularly well-suited for use with a MALDI plate, other target plates, including those not intended for mass spectrometry, may be utilized with the subject invention, such as a glass slide for preparation of multiple isolated samples.

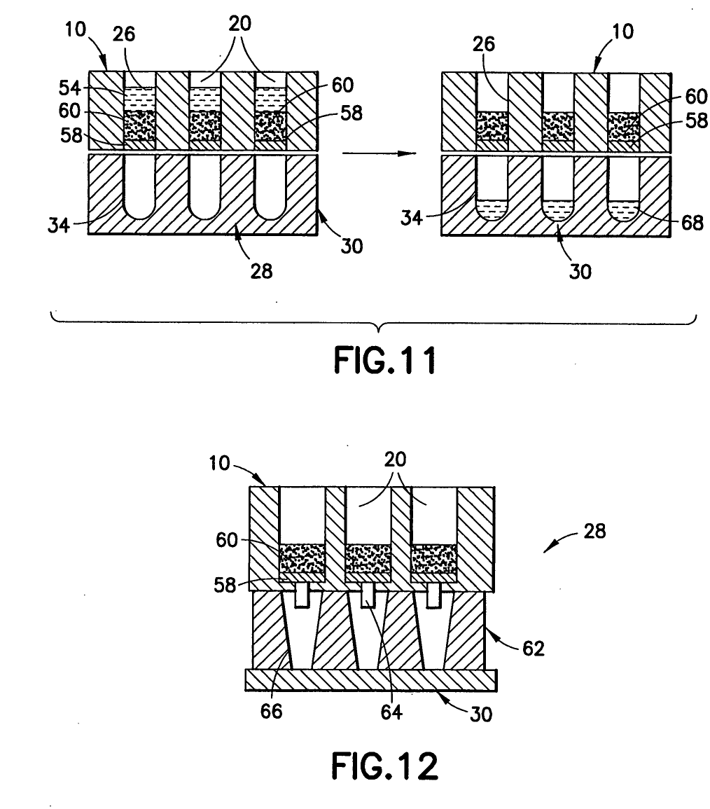

With reference to FIG. 11, the assembly 28 may also be used to allow for liquid sample filtration. The assembly 28 is prepared in any manner described above. FIG. 11 shows the target device 30 as a multi-well plate. Here, at least a portion of the columns 20 of the target support plate 10 are each provided with a frit or filter 58 with filtration media 60, such as chromatography media (e.g., C18 media), being optionally disposed atop the filter 58, as is known in the art. The filtration media 60 may be such that it is capable of retaining a particular class of biological/chemical substances (e.g., proteins/peptides/nucleotides) or a species of small-molecules having a certain physical or chemical property. Optionally, the column sidewalls 26 may be modified by attaching ligands thereto to facilitate filtration. Liquid samples 54 that are to be filtered are disposed in the columns 20, with subsequent centrifuge resulting in the samples 54 being forced through the filtration media 60 and the filter 58 to collect in the collection sites 34 of the target device 30. Filtered solution 68 can then be transferred for further analysis. Filtering can be desired to remove some components in decreasing the background of the mass spectrometry and increasing the sensitivity for detection for other components. For example, a liquid sample is commonly desalted for the MALDI process. Likewise, depletion of high abundant proteins (e.g., albumin and immunoglobin) in human plasma and human serum may be desired to increase detection sensitivity of low abundant proteins.

With reference to FIG. 12, the assembly 28 can be prepared such that the target support plate 10 is releasably secured to a secondary target support plate 62 which, in turn, is releasably secured to the target device 30, such as a mass spectrometric plate. As will be appreciated by those skilled in the art, although it is not envisioned that more than two of the target support plates 10 and 62 are to be used together in forming the assembly 28, the possibility of such an assembly does exist. With the assembly of FIG. 12, the target support plate 10 can be provided with the filter 58 and the filtration media 60 as described above. Exit columns 64 may be optionally provided on the target support plate 10 to channel filtered liquid into secondary collection sites 66 of the secondary target support plate 62. The secondary collection sites 66 collectively define fluid-collecting wells with the target device 30.

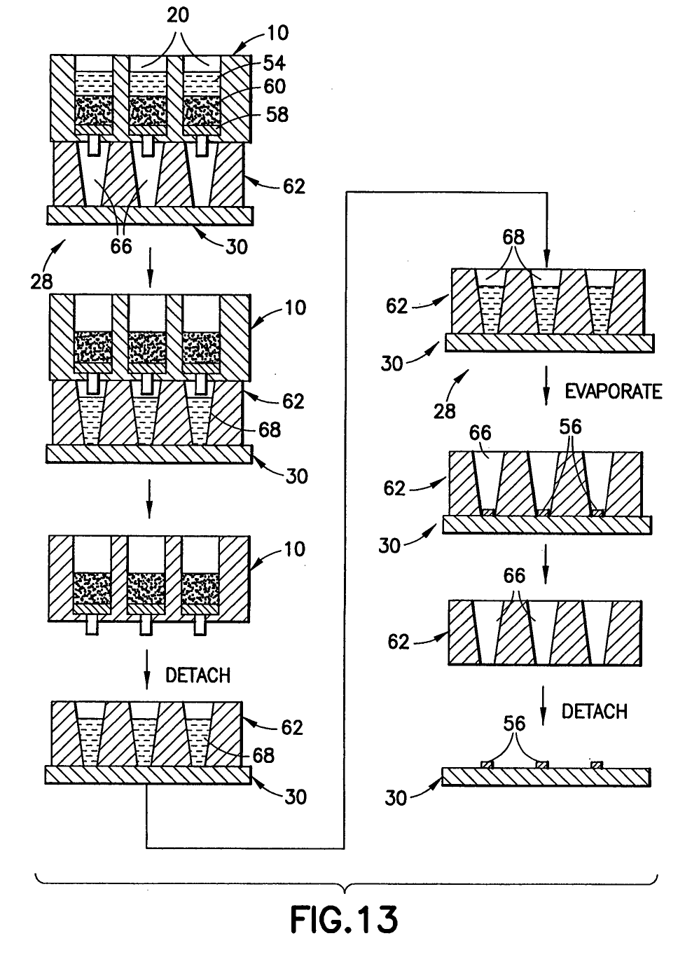

As shown in FIG. 13, the assembly of FIG. 12 can be used to prepare chemical or biological samples for analysis, wherein liquid samples 54 may be initially filtered under centrifuge and collected in the secondary collection sites 66 of the secondary target support plate 62. Thereafter, the target support plate 10 can be detached from the secondary target support plate 62. Filtered liquid 68 collected in the secondary collection sites 66 may then be evaporated to form the conglomerates 56 on the collection sites 34 of the target device 30. Finally, the secondary target support plate 62 may be detached from the target device 30 to allow for analysis of the conglomerates 56.

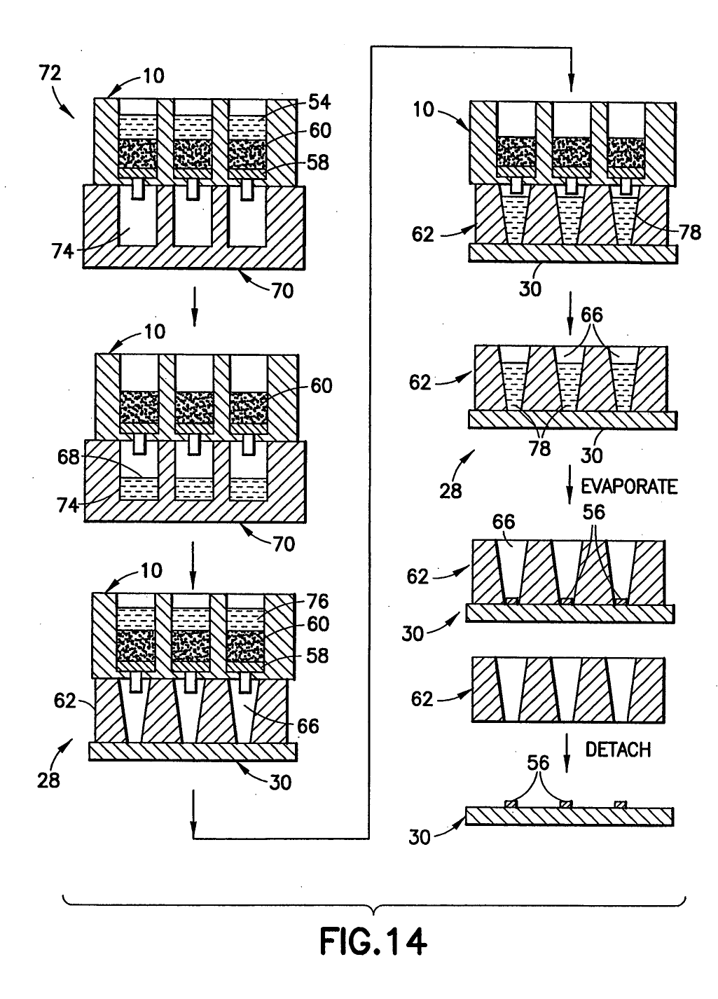

With reference to FIG. 14, and as a variation to the process of FIG. 13, a purification process can be practiced using the subject invention. Initially, the target support plate 10 is releasably secured to a multi-well plate 70 in forming an initial filtering assembly 72 in accordance with any manner described above. Liquid samples 54 are filtered under centrifuge through the filtration media 60 to force waste liquid 68 into collection sites 74 of the multi-well plate 70. Material of interest is, however, retained in the filtration media 60. Washing buffers (not shown) can be flowed through the filtration media 60 to disassociate and wash away components that are non-specifically bound in the filtration media 60. After washing, the target support plate 60 is detached from the multi-well plate 70 and attached to the secondary target support plate 62 in forming the assembly of FIG. 12. Elution buffers 76 (e.g., organic solvents, such as acetonitrile or methanol) are then flowed through the filtration media 60 by centrifuge. The material of interest bound in the filtration media 60 is eluted into the secondary collection sites 66 of the secondary target support plate 62. The target support plate 10 is thereafter separated from the secondary target support plate 62. Eluted liquid 78 collected in the secondary target support plate 62 is caused to evaporate leaving conglomerates 56 collected on the collection sites 34 of the target device 30. To allow for analysis, the secondary target support plate 62 is separated from the target device 30.

This method is useful when deposition of a purified sample is desired. For example, reverse phase resins, such as C18, may be used to purify protein/peptide samples before deposition as the conglomerates 56. Other affinity matrices can also be used as the filtration media 60, such as immobilized metal ion affinity chromatography (IMAC) matrices for phosphorylated peptides/proteins or poly(histidine) fused peptides/proteins, biotin affinity matrices for biotinylated peptide/proteins, and thiol-disulfide exchange chromatography matrices for glutathione S-transferase (GST) fused peptides/proteins.

As will be recognized by those skilled in the art, air and/or liquid-tight seals may be provided on the top surface 14 of the target support plate 10 so that the target support plate 10, with the target device 30 being supported thereby, may be used for storage and/or assay purposes. Portions of the target support plate 10 can also be prepared for affinity capture or depletion (through coating, a membrane, or preparation of the constituent resin with suitable agents). Ligands and/or proteins may also be deposited in the target support plate 10 prior to introduction of the liquid samples 54.

The subject invention provides several advantages over the prior art. For example, larger liquid samples can be provide at collection sites, which when evaporated, provide larger mass depositions for analysis. Also, certain organic solvents (e.g., acetone) which have been difficult to use with prior art devices, due to poor containment, can be utilized with the subject invention and properly contained within the columns of the target support plate without leakage. Further, the open bottom ends of the target support plate can be used to define the size of the resulting conglomerates, thereby avoiding inconsistent or improperly-sized formations.

Various changes and modifications can be made in the present invention. It is intended that all such changes and modifications come within the scope of the invention as set forth in the following claims.

What is claimed is:

1. An assembly for processing biological and chemical samples, said assembly comprising:
a target support plate having spaced-apart top and bottom surfaces, a plurality of columns extending between, and through, said top and bottom surfaces; and
a target device releasably secured to said target support plate, said target device having collection sites for collecting the samples, said columns at least partially registering with said collection sites.

2. An assembly as in claim 1, wherein said target device is releasably secured to said target support plate by adhesive.

3. An assembly as in claim 1, wherein said target device is releasably secured to said target support plate by an elastomeric gasket interposed between said target support plate and said target device, said gasket being releasably adhered to said target device.

4. An assembly as in claim 3, wherein said gasket includes a silicon polymer.

5. An assembly as in claim 3, wherein said gasket includes poly(dimethyl)siloxane.

6. An assembly as in claim 1, wherein, at least said bottom surface of said target support plate is formed of an elastomeric material releasably adhered to said target device.

7. An assembly as in claim 6, wherein said elastomeric material includes a silicon polymer.

8. An assembly as in claim 6, wherein said elastomeric material includes poly(dimethyl)siloxane.

9. An assembly as in claim 6, wherein said target support plate is wholly formed of said elastomeric material.

10. An assembly as in claim 1, wherein said target device is releasably secured to said target support plate by a releasable mechanical fixation.

11. An assembly as in claim 10, wherein said target support plate includes a protruding locking member which, at least, partially bounds said target device, said locking member having an upstanding support member and a transverse member formed such that a portion of the target device is interposed between an engagement surface defined on the transverse member and said bottom surface.

12. An assembly as in claim 11, wherein said locking member is deflectable to release said target device.

13. An assembly as in claim 1, wherein, at least a portion of said columns is each formed with a cylindrical shape.

14. An apparatus as in claim 1, wherein, at least a portion of said columns is each formed with a frusto-conical shape.

15. An assembly as in claim 14, wherein said frusto-conical shaped columns are formed to converge towards said bottom surface.

16. An apparatus as in claim 1, wherein, at least a portion of said columns is each formed with non-constant cross-sections.

17. An assembly as in claim 1, wherein said bottom surface of said target support plate is recessed.

18. An assembly as in claim 17, wherein said bottom surface partially defines a recessed section defined within said target support plate, said recessed section being defined to accommodate said target device within a footprint of said target support plate.

19. An apparatus as in claim 1, wherein said target device is a multi-well plate.

20. An assembly as in claim 1, wherein said target device is a mass spectrometry plate.

21. An assembly as in claim 19, wherein said mass spectrometry is for a purpose selected from the group consisting of MALDI (Matrix-Assisted Laser Desorption Ionization) mass spectrometry, SELDI (Surface Enhanced Laser Desorption/Ionization) mass spectrometry, and DIOS (Desorption/Ionization On porous Silicon) mass spectrometry.

22. An assembly as in claim 1, wherein said target device is a secondary target support plate having spaced-apart top and bottom surfaces, a plurality of columns extending between, and through, said top and bottom surfaces, said columns of said secondary target support plate defining said collection sites.

23. An assembly as in claim 1, wherein, at least fluid-tight seals are defined between said target support plate and said target device at locations between said collection sites so as to prevent cross-contamination between said collection sites.

24. An assembly as in claim 1, wherein, at least a portion of said columns is each provided with a filter.

25. An assembly as in claim 1, wherein, at least a portion of said columns is each provided with a filtration media.

26. An assembly as in claim 1, wherein, at least a portion of said columns is modified chemically.

27. An assembly as in claim 1, wherein, at least a portion of said columns is modified to provide reactivity for certain biological/chemical molecules.

28. An assembly as in claim 1, wherein, at least a portion of said columns is modified by physical attachment of biological/chemical entities thereto.

29. An assembly as in claim 1, wherein, at least, a portion of said columns is modified to minimize non-specific binding of various biological/chemical substances.

30. An assembly as in claim 1, wherein, at least a portion of said columns is modified to specifically bind a class of biological/chemical substances.

31. A target support plate for processing biological and chemical samples, said target support plate comprising spaced-apart top and bottom surfaces, a plurality of columns extending between, and through, said top and bottom surfaces, wherein, at least said bottom surface of said target support plate is formed of an elastomeric material which is releasably adhereable to a target device.

32. A target support plate as in claim 31, wherein said elastomeric material includes a silicon polymer.

33. A target support plate as in claim 31, wherein said elastomeric material includes poly(dimethyl)siloxane.

34. A target support plate as in claim 31, wherein said target support plate is wholly formed of said elastomeric material.

35. A target support plate assembly for processing biological and chemical samples, said assembly comprising:
a target support plate having spaced-apart top and bottom surfaces, a plurality of columns extending between, and through, said top and bottom surfaces; and
means for releasably securing said target support plate to a target device such that said columns, at least, partially register with collection sites of the target device.

36. An assembly as in claim 35, wherein said means for releasably securing said target support plate is selected from the group consisting of an elastomeric gasket, an adhesive, a releasable mechanical fixation, and combinations thereof.

37. A method for processing chemical and biological liquid samples that are to be collected at collection sites on a target device, said method comprising:
releasably securing a target support plate to the target device, said target support plate having spaced-apart top and bottom surfaces, a plurality of columns extending between, and through, said top and bottom surfaces, wherein said target support plate is releasably secured to the target device such that said columns at least partially register with the collection sites of the target device; and,
depositing the liquid samples in at least a portion of said columns.

38. A method as in claim 37, wherein said target support plate is at least partially formed of elastomeric material, and said releasably securing includes pressing an elastomeric portion of said target support plate into contact with the target device.

39. A method as in claim 37, wherein said releasably securing includes adhering said target support plate to the target device with adhesive.

40. A method as in claim 37, wherein said releasably securing includes releasably mechanically fixing said target support plate to the target device.

41. A method as in claim 37, wherein said releasably securing includes interposing an elastomeric gasket between said target support plate and the target device.

42. A method as in claim 37, wherein the target device is a multi-well plate.

43. A method as in claim 37, wherein the target device is a mass spectrometry plate.

44. A method as in claim 37, wherein the target device is a secondary target support plate having spaced-apart top and bottom surfaces, a plurality of columns extending between, and through, said top and bottom surfaces, said columns of said secondary target support plate defining the collection sites.

45. A method as in claim 37, wherein said releasably securing includes defining at least fluid-tight seals between said target support plate and the target device at locations between the collection sites so as to prevent cross-contamination between the collection sites.
